(19) United States
(12) Patent Application Publication
(10) Pub. No.: US 2026/0082866 A1
(43) Pub. Date: Mar. 19, 2026

(54) AUGMENTED CHEMICAL MECHANICAL PLANARIZATION

(71) Applicant: Applied Materials Israel Ltd., Rehovot (IL)

(72) Inventors: Michael SHIFRIN, Ashkelon (IL); Boris LEVANT, Rehovot (IL); Vadim KUCHIK, Kiriat Ekron (IL); Yorick TROUILLER, Grenoble (FR); Aner AVAKRAT, Ohad (IL); Ran YACOBY, Jerusalem (IL)

(21) Appl. No.: 18/888,092

(22) Filed: Sep. 17, 2024

(51) Int. Cl. H01L 21/66; G06F 30/20; G06F 111/20; G06F 119/18; H01L 21/321

(52) U.S. Cl. CPC H10P 74/203; G06F 30/20; H10P 52/403; G06F 2111/20; G06F 2119/18

(57) ABSTRACT

The presently disclosed subject matter includes a method and a computer system dedicated for determining semiconductor specimen topography based on grayscale level (GL) imaging output. According to the disclosed approach, the semiconductor specimen surface is scanned from top-view using an examination tool such as a Scanning Electron Microscopy (SEM) to generate a grayscale level (GL) output image of the scanned surface. The GL output images are processed to deduce the corresponding height values of the scanned semiconductor specimen based on graphical features of the GL output images. The height values are then used for validating CMP hotspot predictions, which enhance the accuracy of hotspot detection and increase the reliability of the dummy fill results.

### TECHNICAL FIELD

The presently disclosed subject matter is related to semiconductor manufacturing.

### BACKGROUND

Chemical mechanical planarization (CMP) plays an important role in semiconductor manufacturing. This process combines chemical etching with physical grinding using abrasive materials to smooth or planarize a semiconductor specimen across layers. It facilitates efficient current flow and effective thermal dissipation in the completed device.

However, CMP can cause device failure due to unwanted variations in surface topography. These variations, for example in the form of dishing or erosion, can lead to different electrical failures such as increased resistivity of metal lines or contacts, or shorts caused by metal residues. Topography variation may also lead to depth of focus marginality in subsequent lithography steps, resulting in undesirable pattern fidelity. Areas in a semiconductor specimen layout that are known to be prone to such failures are often referred to as “hotspots”.

### GENERAL DESCRIPTION

The Chemical Mechanical Planarization (CMP) process is influenced by the pattern density on the semiconductor specimen, wherein the rate of material removal (e.g., copper, metal oxide, tungsten) during CMP is a function of various factors, including, for example, the pattern density. Consequently, variations in density can lead to an uneven surface on the semiconductor specimen post-CMP.

To mitigate variations in pattern density, which affect the uniformity of the CMP process, process-aware layout design and hotspot simulation are integral during the Design for Manufacturing (DFM) phase. DFM encompasses a set of methodologies aimed at designing products to not only simplify, but also optimize their manufacturing processes, thereby improving manufacturability. These methodologies enable designers to proactively address potential process-related issues through improved floor planning and the incorporation of dummy fills. By simulating the effects of height variations resulting from pattern density and adding dummy fills, designers can achieve a more uniform surface height across the semiconductor specimen, thereby achieve producing a more consistent CMP outcome, reducing topographical defects, and enhancing the overall quality of the semiconductor device.

However, conventional optical measurement techniques, such as Optical Critical Dimension (OCD), used for evaluating the surface of the semiconductor specimen both prior to and following CMP, encounter difficulties in precisely measuring and characterizing the dimensional attributes of critical zones. Specifically, OCD exhibits limitations in accurately determining heights in regions where the patterns are non-repetitive and intricate, as is typical in transitional areas.

To ascertain the efficacy of dummy fills, manufacturers are currently constrained to either await the results of electrical testing, which may require several months, or to conduct in-line or cross-sectional-based tests that are not only time-consuming and costly, but often also destructive.

The presently disclosed subject matter includes a computer-implemented method and a computer system dedicated for determining semiconductor specimen topography based on grayscale level (GL) imaging output. According to the disclosed approach, the semiconductor specimen surface is scanned (e.g., from top-view) using an examination tool such as a Scanning Electron Microscopy (SEM) to generate a grayscale level (GL) output image of the scanned surface. The GL output images are processed to deduce the corresponding height values of the scanned semiconductor specimen based on graphical features of the GL output images, including the GL values in the image and other graphical features such as edges, contours, textures, and patterns. The height values are then used for validating the hotspot detection, which enhances the accuracy of hotspot detection and increases the reliability of the dummy fill results.

According to a first aspect of the presently disclosed subject matter there is provided a computer-implemented method of augmenting Chemical Mechanical Planarization (CMP) of a semiconductor specimen, the method comprising:
obtaining data indicative of one or more CMP hotpots in the semiconductor specimen, wherein each CMP hotspot is an area on the semiconductor specimen being suspected of requiring planarity adjustments by dummy fill;
performing a hotspot validation procedure:
   for each CMP hotspot:
   obtaining scanning output (GL) images of the hotspot generated by a Scanning Electron Microscope (SEM);
   extracting from a prestored knowledgebase (e.g., library) height values of the hotspot according to graphical features extracted from the scanning output (GL) images; wherein the knowledgebase comprises data associating graphical features scanning output images generated by the SEM, with respective height values in the semiconductor specimen;
   validating the CMP hotspot by confirming if the height values meet one or more conditions, or rejecting them if they do not;
confirming dummy fill at the CMP hotspot if the CMP hotspot is validated.

In addition to the above aspect, the method according to this aspect of the presently disclosed subject matter can optionally comprise one or more of features (i) to (vii) below, in any technically possible and technically possible combination or permutation:
i. Wherein the hotspots validation procedure comprises, for each CMP hotspot, scanning the CMP hotspot area on the semiconductor specimen using a SEM to generate the scanning output (GL) images.
ii. The method further comprises:
   obtaining the data indicative of one or more CMP hotspots by applying a Design for Manufacturing (DFM) model on a design model (e.g. CAD design) of the semiconductor specimen;
   in case the hotspot is validated, updating the design model to include simulated dummy fill at the CMP hotspot area to thereby obtain an updated design model; and re-applying the DFM model on the updated design model to receive data indicative of one or more CMP hotspots in the semiconductor specimen.
iii. The method further comprises:
   obtaining the data indicative of one or more CMP hotspots by applying a Design for Manufacturing (DFM) model on a design model (e.g. CAD design) of the semiconductor specimen; providing feedback to DFM model and updating the DFM model according to the validation output, thus augmenting the DFM model.
iv. The method further comprises an offline phase executed before the execution of the hotspot validation procedure, the offline phase comprising:
   generating a 3D physical model of the semiconductor specimen based on structural and material characteristics;
   determining stack information of the semiconductor specimen;
   configuring, based on the stack information and the 3D physical model, a simulation engine adapted to correlate graphical features extracted from SEM imaging output images, with corresponding height values in the semiconductor specimen.
v. The method further comprises calibrating the simulation engine, comprising:
   obtaining scanning output images of a selected area in the semiconductor specimen that comprises CMP hotspots;
   applying graphical features extracted from the scanning output images to the simulation engine to thereby obtain respective height values;
   measuring height values in the selected area using a high-resolution imaging technique to obtain measured height values;
   determining a calibration coefficient based on a difference between the respective height values and measured height values; the calibration coefficient is dedicated for correcting errors in height values determined by the simulation engine.
vi. Wherein the offline phase further comprises:
   applying the simulation engine on graphical features extracted from different areas in the semiconductor specimen to determine respective height values; storing the graphical features and their respective height values as entries in a database, each entry corresponding to graphical features and respective height values generated, provided by the simulation engine.
vii. The method further comprises restricting application of the simulation engine to areas that exhibit topography that aligns with an expected range of height variations to thereby reduce processing load and time needed for generating the database.

According to a second aspect of the presently disclosed subject matter there is provided a computer system comprising at least one processing circuitry configured to execute a method according to the first aspect.

According to a third aspect there is provided a non-transitory computer readable medium comprising instructions that, when executed by a computer, cause the computer to perform a computer-implemented method of augmenting Chemical Mechanical Planarization (CMP) of a semiconductor specimen, as described above with respect to the first aspect.

The system, the non-transitory program storage device, the computer program product, and the examination system disclosed above, can optionally comprise one or more of features (i) to (vii) listed above, mutatis mutandis, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating a system, in accordance with certain examples of the presently disclosed subject matter;

FIG. 2 is a more detailed block diagram of certain components in the system, in accordance with certain examples of the presently disclosed subject matter;

FIG. 3 is a flowchart of operations carried out as part of a Chemical Mechanical Planarization (CMP) hotspot analysis process as known in the art;

FIG. 4a is a flowchart showing operations carried out as part of a topography simulation process, in accordance with certain examples of the presently disclosed subject matter;

FIG. 4b is a flowchart showing operations carried out for determining height values of hotspots using a knowledgebase, in accordance with certain examples of the presently disclosed subject matter;

FIG. 5 shows at the top is a schematic depiction of a physical model from side view, and at the bottom a schematic depiction of the physical model from top view, in accordance with certain examples of the presently disclosed subject matter; and

FIG. 6 is a modified version of the flowchart shown in FIG. 3, demonstrating the incorporation of a knowledgebase validation procedure as part of the CMP analysis process, in accordance with certain examples of the presently disclosed subject matter.

### DETAILED DESCRIPTION

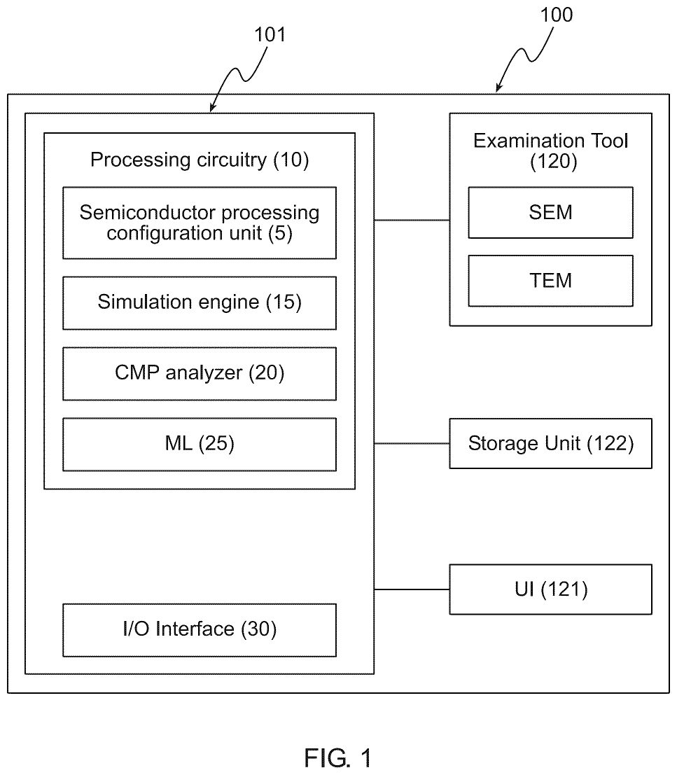

Bearing the above in mind, attention is drawn to FIG. 1, which is a generalized block diagram illustration of a computer system 101 configured to execute a CMP hotspot analysis process, according to examples of the presently disclosed subject matter. FIG. 1 shows a non-limiting example where computer system 101 is integrated with a semiconductor examination system 100. Examination system 100 can be used for examination of a semiconductor specimen (e.g., a wafer, a die) e.g., as part of the specimen fabrication process, and particularly as part of the CMP hotpots analysis process, as further described below. System 100 can comprise one or more examination tools 120 configured to scan a specimen and capture images thereof to be further processed for various examination applications.

There are various types of examination tools which can be used in the semiconductor examination process, including, for example, optical microscopy, electron beam inspection machines (e.g., a Scanning Electron Microscope (SEM), or a Transmission Electron Microscope (TEM), etc.), Atomic Force Microscopy (AFM), X-ray microscopy, and so on.

According to one example, examination tools 120 include a Scanning Electron Microscope (SEM). SEMs are a type of electron microscope that produces grayscale level (GL) images of a semiconductor specimen by scanning it with a focused beam of electrons. The operation of an SEM involves directing a focused beam of high-energy electrons toward a sample surface. This electron beam is generated by an electron gun and then precisely focused and directed using electromagnetic lenses. As the electron beam scans across the surface of the sample, it interacts with the atoms, leading to various outcomes such as the emission of secondary electrons, backscattered electrons, and characteristic X-rays.

The detection of secondary electrons (emitted from atoms near the surface) allows for high-resolution imaging of the sample's topography. Backscattered electrons, which are the primary electrons electromagnetically deviated from the sample atoms, provide information on the composition and contrast, based on atomic number differences within the sample. In some examples, tilted beam techniques can be used in semiconductor manufacturing for detailed topographical analysis. These methods, applied in tools like Scanning Electron Microscopy (SEM) and Atomic Force Microscopy (AFM), provide enhanced 3D surface information, revealing critical features such as textures, edges, and step heights of semiconductor materials.

Detectors designed for specific types of emissions capture the signals resulting from these interactions. This collected data is then processed to produce a grayscale image, indicating the quantity of electrons captured by the detector. This number of collected electrons varies, depending on the surface topography, composition, or other properties of the sample. Through this process, an electron beam examination tool such as a SEM can generate highly detailed grayscale images of the sample surface at magnification levels unattainable with traditional optical microscopes, providing precise inspection and measurement capabilities during the manufacturing of semiconductor wafers.

Examination tools 120 can also include a Transmission Electron Microscope (TEM), which is a powerful microscopy technique that uses a beam of electrons to visualize and analyze the microstructure of materials at very high resolutions, often down to the atomic level. TEM operates by transmitting a high-energy electron beam through an ultra-thin specimen. As the electrons interact with the sample, they are either scattered or transmitted, producing a detailed image based on the atomic structure and thickness variations within the sample.

Despite the important insights TEM provides into material structures, it is an inherently destructive technique. The sample preparation process requires specimens to be extremely thin, often only a few atoms thick, which can alter or damage the original material properties. Additionally, the high-energy electron beam can induce changes in the material, such as knock-on damage, radiolysis, or contamination, further modifying the sample during examination. This destructive nature means that samples may not be suitable for further use after TEM analysis, necessitating careful consideration when selecting this method for semiconductor examination.

Per the illustrated example, computer system 101 comprises processing circuitry 10 configured to execute various processing operations as further disclosed herein. Processing circuitry 10 can comprise one or more processors and one or more memories (not shown). In some examples, the processing circuitry is configured to execute several functional modules in accordance with computer-readable instructions implemented on a non-transitory computer-readable memory comprised in the processing circuitry. Such functional modules are referred to hereinafter as comprised in the processing circuitry. FIG. 1 illustrates, by way of example, processing circuitry 10 comprising semiconductor processing configuration unit 5, simulation engine 15, and CMP analyzer 20.

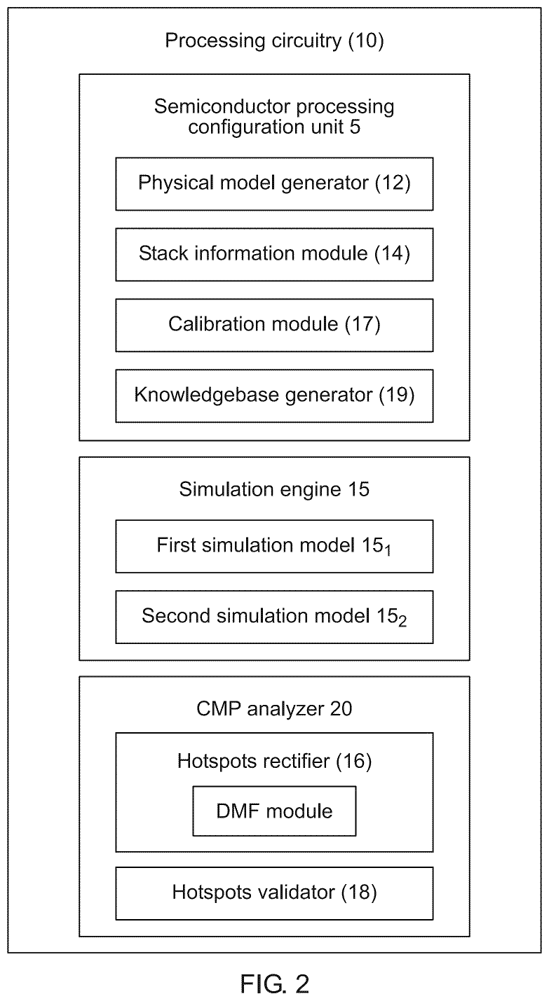

FIG. 2 shows a block diagram of a detailed view of functional modules of certain components of system 101, according to a non-limiting example, including processing configuration unit 5, simulation engine 15, and CMP analyzer 20. The functional modules depicted as part of processing configuration unit 5 include: physical model generator 12 configured to generate a 3-dimensional physical model of a semiconductor specimen; stack information module 14 configured to obtain and manage stack information; calibration module 17 configured the simulation engine; and knowledgebase generator 19.

The functional modules depicted as part of CMP analyzer 20 include hotspots rectifier 16 and hotspots validator 18, where hotspots rectifier 16 is configured to identify locations of CMP hotspots and provide dummy fill simulations, and hotspots validator 18 is configured to validate hotspots inferred by hotspots rectifier 16.

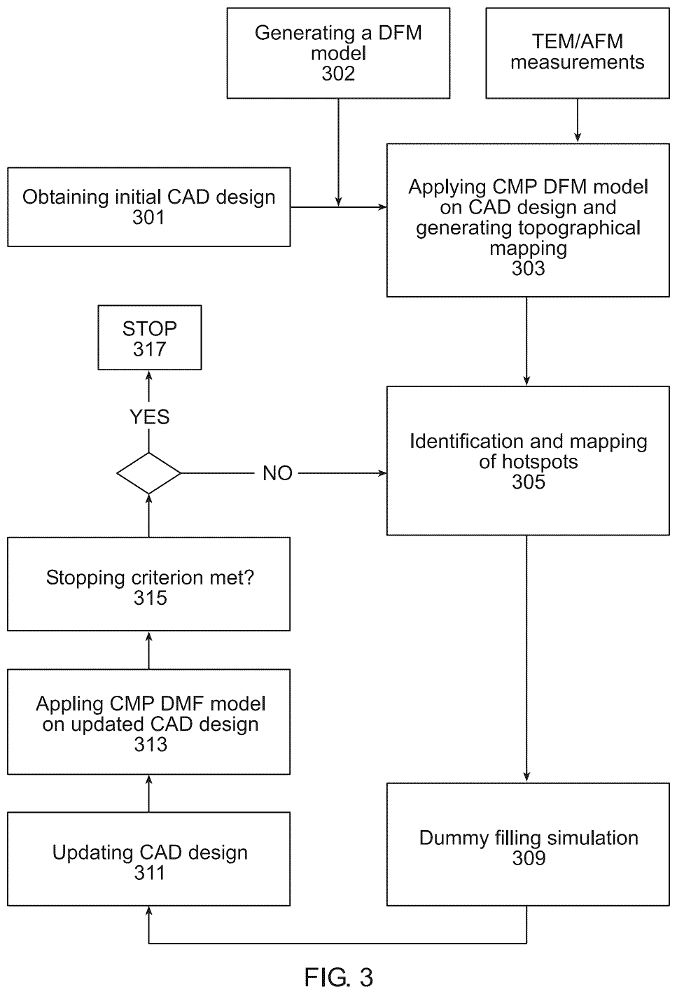

The functional modules depicted as part of simulation engine 15 include simulation module 15₁ and simulation module 15₂. Simulation engine 15 is configured to generate and apply a simulation engine dedicated for simulating the relation between GL values in a scanned imaging output of a semiconductor specimen and the topography of the semiconductor specimen. Specific operations related to processing circuitry 10 and its components are described below with reference to FIGS. 3 to 6.

System 100 and/or 101 can comprise or be otherwise operatively connected to a data-storage unit 122. The data storage unit 122 can be configured to store any data necessary for the operation of the system, including for example computer software which is loaded during execution of any one of the modules described above, intermediate processing results generated by system 100, examination output images, the physical model generated by physical model generator 12, the stack-data, etc.

In some embodiments, system 100 can optionally comprise a user interface 121 to enable user interaction with system 100 and/or system 101. The user interface can include a display device, user interaction devices (e.g., computer mouse and keyboard) and a graphical user interface (GUI) configured to enable, inter alia, user-specified inputs related to system 100 and/or 101. For instance, the user may define, through the GUI, parameters and control operations of the system. The user may also view on the display and manipulate the processing results or intermediate processing results, such as, e.g., outputs of CMP analyzer, a graphical presentation of the physical model, etc.

It is noted that, in some examples, at least some of examination tools 120, storage unit 122, and/or UI 121, can be located remotely from system 100 and connected over a remote data communication link, such as through a cloud computing environment or a wide-area network. In these cases, the remote components operate in communication with system 100, e.g., via I/O interface 30.

Referring to FIG. 3, it shows a flowchart of operations carried out as part of a Chemical Mechanical Planarization (CMP) hotspot analysis process as known in the art. FIG. 3 represents a methodological framework designed to enhance the planarity of semiconductor specimens during their design phase.

The process begins with the generation or acquisition of a computer-aided design (CAD) of a semiconductor specimen that is being examined (block 301). This CAD design specifies structural properties including variations in pattern density, which are important for assessing the planarity and functional integrity of the semiconductor specimen.

A Design for Manufacturability (DFM) model is generated, tailored to analyze the planarity of the semiconductor specimen based on the specified pattern densities (block 302). The DFM model takes into account the interactions between the physical layout of the semiconductor specimen as represented in the CAD (e.g., by identifying areas of high and low pattern density) and manufacturing variables.

This model is virtually tested for its ability to predict and manage variations in topography due to different pattern densities. Metrological techniques such as Transmission Electron Microscopy (TEM) and Atomic Force Microscopy (AFM) are used to measure the actual dimensions of the semiconductor specimen and verify any deviations in the model's prediction of height values, ensuring that the model accurately reflects the physical reality of the semiconductor specimen's topography.

The DFM model is applied to the CAD design of the semiconductor specimen to create a detailed thickness profile (or topographic map) of the semiconductor specimen and generate a topographical mapping of the specimen (block 303). The DFM model integrates CAD data to simulate the expected topographical outcome, which includes identifying potential hotspots based on pattern density and layout complexity. The topographic map assigns predicted height values to each point (e.g., each pixel coordinate) on the semiconductor specimen, offering a comprehensive visual representation of the semiconductor specimen's planarity before physical fabrication.

Hotspots are identified and mapped on the topographic map (block 305). These hotspots are typically located in transition areas where pattern diversity is significant and are potentially problematic, indicating regions where planarity adjustments are necessary. In some examples, a hotspot map is obtained, which highlights the critical areas (hotspots) identified in the previous step. This map serves as a guide for subsequent corrective actions.

Identifying hotspots of uneven planarity involves comparing height values against threshold values. One method defines the threshold as a deviation from a nominal height value of the semiconductor specimen. If the deviation of the height exceeds this threshold, a hotspot is indicated. For example, if the nominal height is 100 nm and the threshold deviation is set to 5 nm, any point with a height outside the range of 95 nm to 105 nm would be considered a hotspot. Another method defines the threshold based on the gradient between two points. If the gradient (rate of change of height) between two closely spaced points exceeds a certain value, this indicates a hotspot. Both methods ensure precise detection of uneven planarity on the semiconductor surface.

As mentioned above, dummy fill in semiconductor design involves adding non-functional patterns to the semiconductor specimen layout. These patterns do not contribute to the electrical functionality of the semiconductor specimen but are crucial for manufacturing purposes as they reduce pattern density variations and enhance the uniformity of the wafer surface, which is essential for obtaining consistent results during the CMP process. During the CMP hotspot analysis process, which precedes the actual CMP process, dummy fill simulation is performed (block 309). Dummy fill simulation is dedicated for simulating the addition of dummy fills where they will be most effective. Following the dummy fill simulation, the CAD design is updated to reflect the modifications made (block 311). This updated design incorporates the changes and serves as the basis for further analysis.

Following the update of the CAD design, the DFM model is reapplied to the updated CAD design to verify that the hotspot adjustments have been successfully resolved and to identify any additional hotspots on the semiconductor specimen (block 313). This iterative process can be repeated until a stopping criterion is met (block 315). For example, the process may continue until a planarity metric calculated by the DFM model falls below a predefined threshold value, indicating that all hotspots have been sufficiently addressed and the semiconductor specimen's planarity meets the design specifications, or until the maximum number of permitted iterations is reached.

Once the CMP hotspot analysis process is completed and the layout (as prescribed by the finalized CAD design) of the semiconductor specimen is finalized (block 317), the finalized CAD design can be used during the dummy fill process, which is a physical process of adding dummy features to the semiconductor specimen. Subsequently, the design dummy features are transferred to the physical wafer, e.g., through the standard lithography, deposition, and etching processes.

As mentioned above, despite calibration, the DFM model remains susceptible to inaccuracies due to its failure to consider variations across different machines and product batches. As a result, adjustments made through dummy fill are suboptimal, manifesting as inconsistencies in surface topography. Moreover, the metrological techniques employed (e.g., OCD) are ineffective in identifying these deficiencies. These deficiencies can only be detected at the end of the process following manufacturing, causing potential delays and increased costs due to the need for rework and loss of material.

A novel technique is disclosed herein that utilizes SEM output images of semiconductor specimens to determine height variations in the semiconductor specimen. This technique can be applied to hotspots identified by the DFM model, thereby validating the model's detection of hotspots. By iteratively refining the DFM model, this approach enhances its accuracy in hotspot detection and increases the reliability of the dummy fill results.

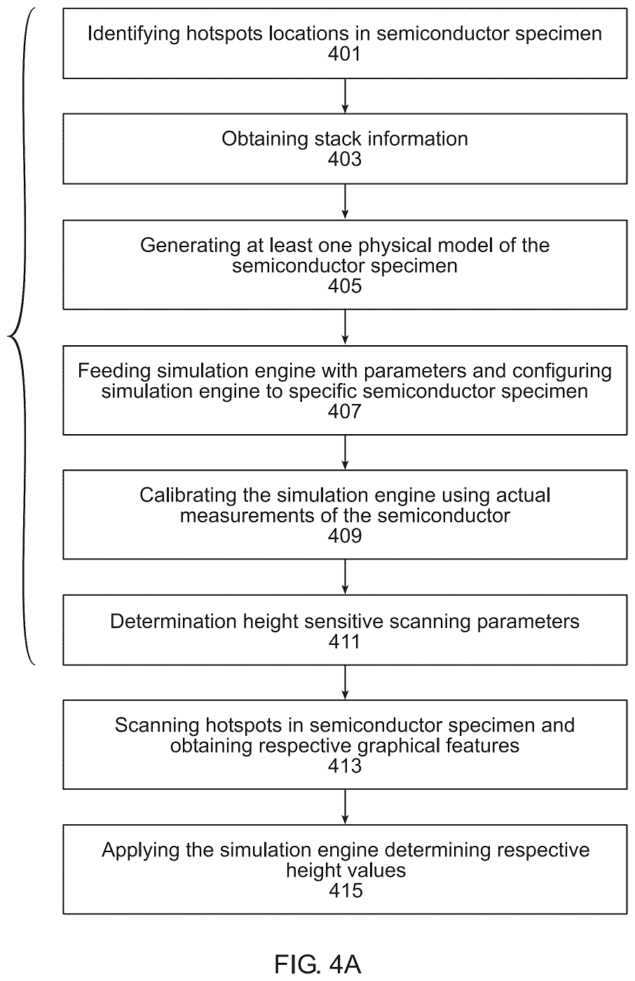

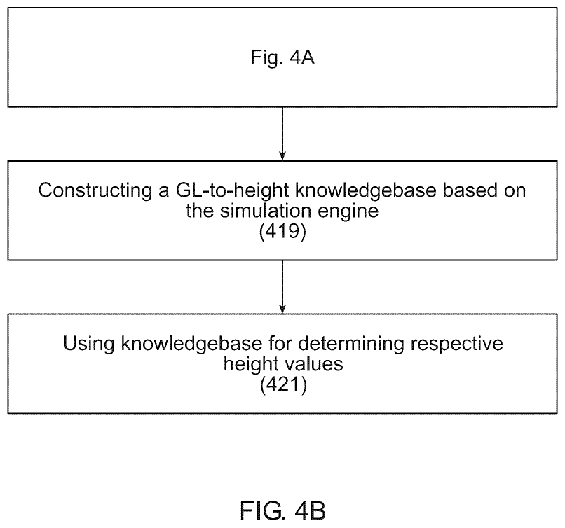

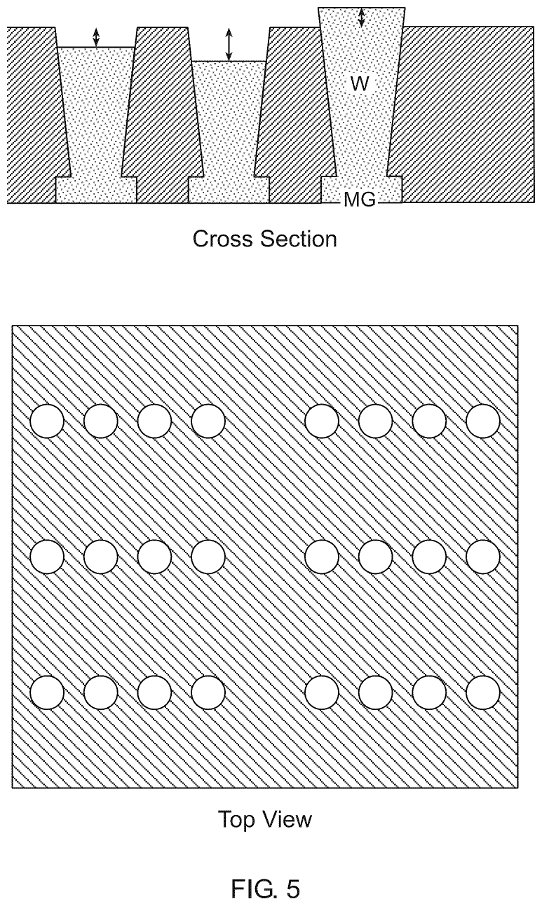

FIG. 4a is a flowchart showing operations carried out as part of the topography simulation process, according to some examples of the presently disclosed subject matter. For the sake of clarity and completeness, and by way of non-limiting example only, operations in FIG. 4a are described with reference to components of system 100 shown in FIGS. 1 and 2. Generation of the simulation model can be carried out by semiconductor processing configuration unit 5 and simulation engine 15. Operations described with reference to blocks 401 to 411 in FIG. 4a (marked by the brace on the left) pertain to generation of the simulation engine and determination of height-sensitive parameters.

A group of semiconductor specimens that share common manufacturing conditions, including material and structural attributes, may be referred to as a “fleet of specimens”. In semiconductors that belong to the same fleet of specimens, a particular relationship exists between the response of the SEM scanning and the topography (or height) of the features on the semiconductor specimen's surface. This relationship allows for the accurate mapping of height variations based on the GL features including the intensity of the SEM output images, thereby facilitating a precise understanding of the semiconductor specimen's physical dimensions and potential manufacturing irregularities.

Accordingly, for a specific semiconductor specimen of a certain fleet, with a particular design, physical properties of the specimen are obtained, and a three-dimensional (3D) computer generated physical model is built based on various characteristics of the semiconductor specimen including its various (nominal) dimensions and material compositions, which are prescribed, inter alia, by the semiconductor design. As further explained below the physical model is used in the determination of the topography (and particularly the height) at various points on the semiconductor specimen based on top-view grayscale scanning output obtained from the SEM.

FIG. 5 shows at the top a schematic illustration of a physical model of a semiconductor specimen from side view, and at the bottom the physical model from top view, demonstrating the scanning angle of the SEM. The information obtained by the top-view scanning is limited to grayscale level information.

The physical model is generated for a particular area or location in the semiconductor specimen. Therefore, initially hotspots' locations are obtained (block 401). Hotspots can be identified in different ways. One way involves the use of different inspection tools such as an AFM which can be applied on a semiconductor specimen. Another way, which was described above with reference to blocks 303 and 305 in FIG. 3, is by applying a DFM model on a CAD design of the semiconductor model. As explained above, the DFM model provides a topographic map with predicted height values at different points on the semiconductor specimen. The map can then be processed to identify hotspots and generate a corresponding hotspots map indicating the location of hotspots in the semiconductor specimen. In some examples, DFM model can be implemented by a dedicated DFM module implemented as part of CMP analyzer 20.

Following identification of hotspots, stack information of each hotspot is determined (block 403; e.g., by stack information module 14). Stack information generally refers to a comprehensive dataset of properties characterizing the layered architecture of a specimen. This dataset includes parameters defining the physical attributes of the specimen's constituent layers such as material composition and layer thickness. It serves as a foundational dataset for simulation modeling and analysis, enabling accurate representation and predictive assessment of the specimen's behavior under various conditions, including electron irradiation in semiconductor imaging applications.

Non-limiting examples of parameters that may be part of the stack information include:
material data/composition: the specific materials composition used in each layer, (e.g., Silicon Oxide (SiOx) and Tungsten). The type of materials directly affects the electron yield during SEM scanning, which in turn influences the SEM response observed;
The dimensions of the semiconductor specimen structure, as it may impact how the SEM beam interacts with different features, including for example: thickness and geometric dimensions of structural features on each layer (e.g., the lateral dimensions and shapes of structural elements within each layer, such as line widths, spacing, and geometrical features also known as critical dimensions);

Additional features that may be included in the stack data are the density, crystalline structure, and orientation of the semiconductor material, which are factors that influence the electrical properties and performance of semiconductor specimens.

Once the stack information is available it is used for generating one or more physical models of the semiconductor specimen (block 405; e.g., by physical model generator 12). As a physical model depends on the specific characteristics of the corresponding area in the semiconductor specimen it represents, more than one physical model may be generated, each for a different hotspot with different structural and material attributes, and, accordingly, different stack data. On the other hand, given the repetitive patterns often observed in semiconductor specimens, a common physical model and stack information can frequently be used for different hotspots.

Each physical model and its respective stack information of a specific hotspot are fed into a simulation engine 15, which is configured based on these parameters (block 407). The configuration of the simulation engine 15 enables it to correlate pixel intensity values (and other graphical features) extracted from SEM imaging output, with corresponding height values in the specimen.

The simulation engine is comprised of several models (or algorithms) which mathematically represent the physical interactions between the SEM electrons and the semiconductor specimen according to its specific materials and physical structure. Based on the input data, the simulation engine simulates the response observed during SEM scanning. Specifically, given the characteristics of the semiconductor specimen and the examination tool parameters (which are described below), it simulates the electrons that will be reflected from the specimen and captured by the SEM detector, resulting in the SEM output. For example, for a specific height variation (e.g., of a trench) or a side wall angle (e.g., of a trench) in the semiconductor specimen, the simulation engine provides a corresponding simulated pixel intensity (or electron yield).

As mentioned above, when an electron beam strikes a specimen, electrons are backscattered by the specimen and sensed by detectors of the examination tool. This produces a signal (pixel intensity signal) informative of the specimen. The term “electron yield” refers to the ratio of the quantity of backscattered electrons to the quantity of incident electrons from the electron beam that strike a specific region of the specimen (such as the bottom of a trench or hole). This yield is indicative of the material composition and topography of the region being examined.

The backscattered electrons are collected and detected by the detectors of the examination tool. The detectors generate a corresponding signal, which corresponds to the pixel intensity profile of the specimen. In other words, the pixel intensity profile depends on the electron yield and on the collection and detection properties of the examination system. Thus, the pixel intensity profile is related to the material composition and topography of the region being examined.

Based on the various parameters provided as input to the simulation engine including the physical model and stack information, the simulation engine 15 is configured to simulate (e.g., using Monte-Carlo simulations) the corresponding electron yield or, more generally, the corresponding pixel intensity. The simulation engine 15 is used to simulate the pixel intensity profile and/or the electron yield of a specimen, for different values of the height and/or to determine the electron yield for different values of other parameters, different from the height. This enables correlating the sensitivity of the electron yield to the height and to the other parameters of the specimen.

As mentioned above, in some examples, the simulation engine 15 includes a first simulation module 15₁ implementing a first simulation model, which models the electron yield, and a second simulation module 15₂, implementing a second simulation model, which models collection and detection of the electrons by the detectors of the examination tool (in particular, an electron beam tool such as SEM).

The first simulation module 15₁ can be configured to perform, based on the input data, a first simulation representative of interaction between irradiated electrons of a beam (primary beam) of the SEM and the specimen. Note that the first simulation module 15₁ can take into account parameters of the beam of the examination tool (“examination tool parameters”; see examples hereinafter). The first simulation module 15₁ can output data indicative of the electron yield of the specimen irradiated by the beam. In some examples, the first simulation module 15₁ can output a map representative of distribution of escaped electrons in terms of polar angle and escape energy.

An examination tool, such as an electron beam tool (e.g., SEM), is typically configured with multiple examination tool parameters characterizing the examination tool, including for example, a set of primary beam parameters and a set of tool imaging parameters. By way of example, the set of primary beam parameters characterize the beam emitted from the electron source of the electron beam tool, and can comprise at least some of the following parameters: landing energy, beam resolution, current amplitude, current density, electron source characteristics, lens settings, aperture size, and numerical aperture (NA), which collectively define the characteristics of the primary beam, such as the spatial extent and focus of the beam.

By way of example, for a given landing energy, the first simulation model 15₁ simulates the beam being directed towards the specimen, where interactions occur based on the material parameters and structural parameters previously defined (by the physical model and stack information). By way of example, electron-solid interactions, including secondary electron emission, electron back-scattering, absorption, etc., can be simulated to elucidate the distribution and behavior of primary and escaped electrons within the semiconductor specimen. The simulation can also track the trajectories of irradiated electrons as they traverse through the specimen, considering the effects of parameters, such as varying landing energy, beam resolution, and current density, on electron transport and interaction mechanisms within the material.

Upon interaction with the specimen, a subset of electrons, such as secondary electrons (SEs), and/or backscattered electrons (BSEs), may escape from the specimen surface, carrying information on its composition, dimensions, defectivity, and surface characteristics. In the simulation engine, the traces of these escaped electrons are tracked using a tracing algorithm, accounting for their energy, direction, and scattering behavior as they propagate through the tool. Specifically, in some examples, the tracing algorithm can use two models, one model characterizing the electron beam tool's column (which houses the electron source and lenses) (also referred to as a column model), and a second model characterizing the electron beam's chamber (e.g., the vacuum chamber housing the specimen) (also referred to as a chamber model).

By way of example, the column model can be constructed, incorporating geometrical dimensions and material compositions of each component in the column to simulate electron optics and beam propagation. This model accounts for electron scattering, focusing, and deflection mechanisms within the column, ensuring accurate representation of electron trajectories as they interact with the specimen. A chamber model can be developed to characterize the electrostatic and electromagnetic fields within the machine chamber surrounding the electron beam tool. This model considers the spatial distribution of charge, potential, and magnetic fields generated by the electron beam and other system components, such as vacuum pumps, shielding, and stage mechanisms.

For a given landing energy, the first simulation can generate output data, e.g., in the form of a map, representing the spatial distribution of escaped electrons in terms of polar angle and escape energy.

The term “polar angle” refers to the angle measured from a reference axis (e.g., the optical axis, which is the surface normal) to the direction in which an electron escapes from the specimen. In the context of electron microscopy, this angle provides information on the directionality of electron emission from the specimen surface. A polar angle of 0 degrees would correspond to electrons escaping perpendicular to the surface, while larger angles represent deviations from this perpendicular direction. The term “escape energy” represents the kinetic energy of the escaped electrons as they leave the specimen surface.

The second simulation module 15₂ can be configured to perform a second simulation representative of collection and detection of the escaped electrons. The second simulation module 15₂ can receive, as an input, the output of the first simulation module 15₁, such as the map. The second simulation module 15₂ can simulate the pixel intensity profile of the specimen.

The set of tool imaging parameters, as part of the examination tool parameters, characterize the collection and detection of the escaped electrons so as to form an imaging signal. By way of example, the set of tool imaging parameters can comprise at least some of the following parameters: detector angle, detector gain, defector offset, electrostatic field, voltage, mechanical configuration, dwell time, scanning speed, pixel size, and energy filter of the electron beam tool.

For a given landing energy, the second simulation models the collection of escaped electrons by different detectors positioned at specific angles and orientations relative to the specimen. The output map from the first simulation can be used as an input to the second simulation, to determine the expected distribution of escaped electrons entering different detectors. This involves modeling the trajectories of escaped electrons as they travel from the specimen surface to the detectors. The efficiency of electron collection can be influenced by parameters such as, e.g., detector angle, deflector offset, and electrostatic field, which determine the trajectories of escaped electrons towards the detectors.

The second simulation model 15₂ then models the detection of the collected electrons by the detectors to generate a simulated pixel intensity profile. In one example, the signal detected by a given detector can be simulated, based on a correlation between the detector gain and the hitting energy (e.g., the energy level at which the electrons hit/enter the detector, also referred to as energy of incoming electrons of the detector), and optionally also hitting current (e.g., the current level at which the electrons hit/enter the detector, also referred to as current of incoming electrons of the detector).

Given the specific physical model and stack information provided to the simulation engine as input, the simulation engine output enables to correlate between the height values of the specific semiconductor specimen and simulated pixel intensity values (GL values) and other graphical features. During runtime the simulation engine can be used for simulating height values based on pixel intensity values obtained by the SEM.

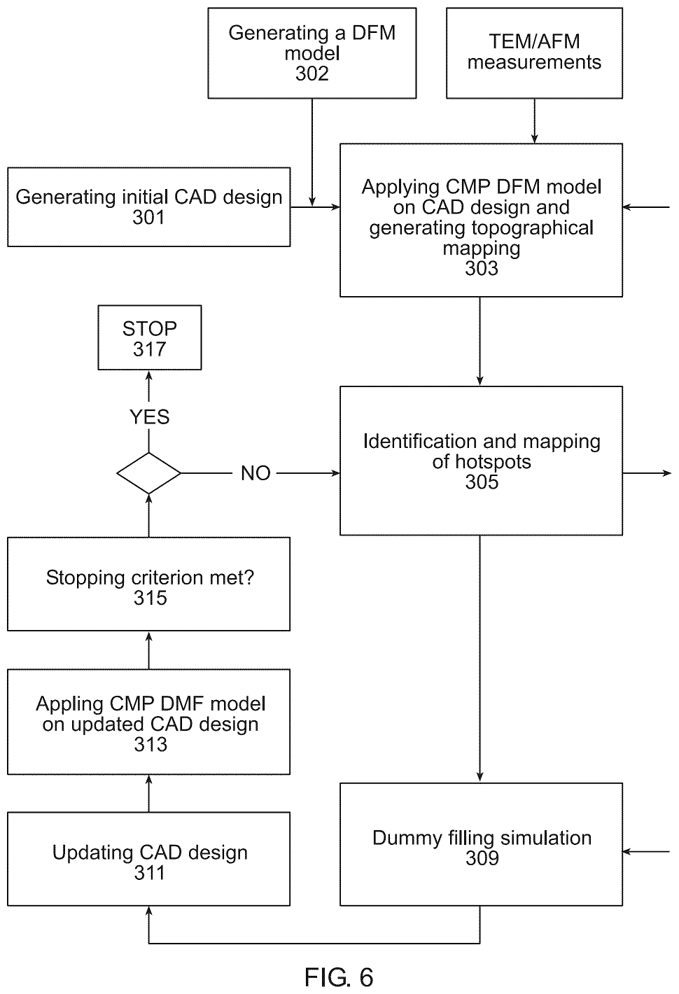

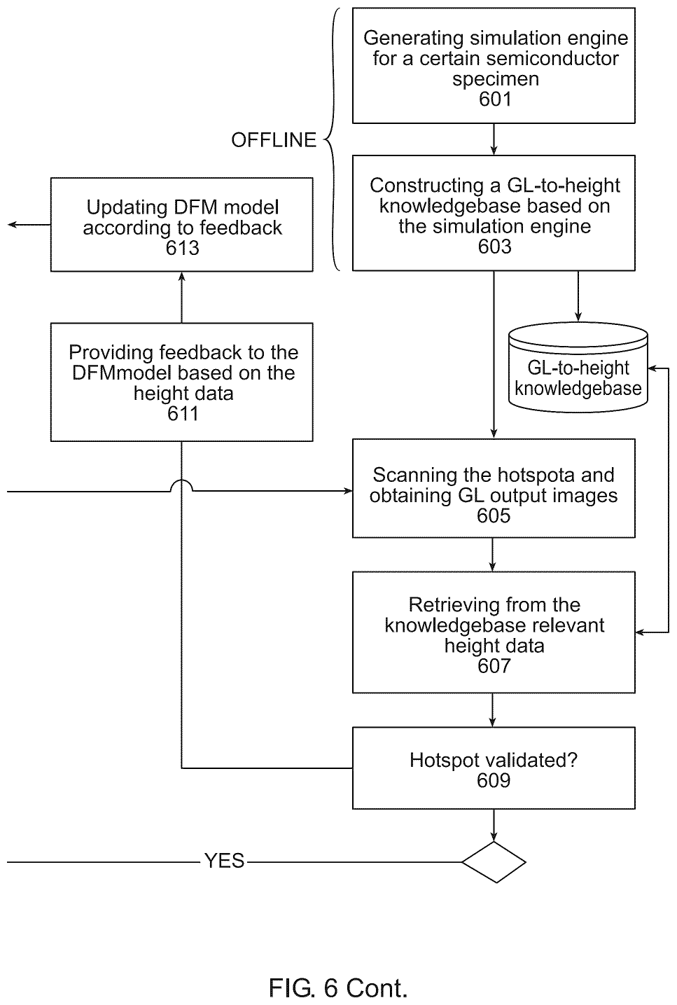

In some examples, the simulation engine 15 is also used for determining examination tool parameters that define settings applied to the SEM that increase sensitivity of the SEM to variations in height and reduce sensitivity to other parameters (also referred to herein as “height-sensitive parameters”; block 409). The height-sensitive parameters include, for example, one or more of landing energy, focus, scan speed, number of pixels, field of view, etc. To this end, the simulation engine is used for applying multiple simulations, where, in different simulations, a different combination of examination tool parameters is used. The scanning output provided by the simulation is analyzed to determine which parameters exhibit high sensitivity to height variations in the semiconductor specimen, while exhibiting low sensitivity to other structural and/or pattern variations. The combination of tool parameters that show the best results (“height-sensitive parameters”) are used during the scanning of the semiconductor as part of the CMP analysis process described below with reference to FIG. 6.

In some examples, to improve model accuracy, external references are used for obtaining a ground truth and calibrating the simulation engine (block 411). During calibration one or more selected areas with hotspots (“sample hotspots”) are processed using the SEM and the simulation engine to determine the respective height values. A cross section of the selected area is extracted from the semiconductor specimen and measured using a high-resolution imaging technique such as Transmission Electron Microscopy (TEM). The TEM provides height measurements (herein “measured height values”) with sub-nanometric accuracy which are compared to the height values obtained by the simulation engine and enables to determine corrected height values. In some examples, calibration module 17 is configured to receive the measurements from the TEM (examination tool 120) and apply it for calibrating the simulation engine.

Table 1 below shows a simplified example of height values obtained from the physical model and calibrated by TEM.

| Grayscale in SEM output | Height by simulation engine | | Height by TEM |
|---|---|---|---|
| 7 | 1 | nanometer | 0.7 nanometers |
| 8 | 1.5 | nanometer | 1.3 nanometers |

Based on the difference between the height values obtained by the simulation engine and those measured by the reference method (TEM), a calibration coefficient is determined. This calibration coefficient can be used to correct errors in the height measurements provided by the simulation engine, thereby improving its accuracy. In some examples, the calibration coefficient is a constant value, while, in other examples, it is variable, depending on various other factors in addition to the height difference. The calibrated simulation engine can be used for converting graphical features obtained by SEM to the corresponding height values.

Once the simulation engine and height-sensitive parameters are available, hotspots in the semiconductor specimen (i.e., the semiconductor specimen used as a basis for the physical model) are scanned using a SEM to obtain respective scanning output including pixel intensity values (GL values) (block 413). In some examples, image processing is applied on the SEM output images to extract additional graphical features from the images. Scanning is performed while the SEM is configured with the height-sensitive parameters. As explained above, hotspots can be identified by the DFM model which is applied on the CAD design.

The simulation engine is applied on the scanning output of the hotspots to convert the GL intensities and other graphical features in the images to the respective simulated height values (also referred to as “simulated height values”; block 415). As further explained below, in some examples the information obtained from the simulation engine can be used for providing feedback, either confirming or correcting the DFM model output indicating hotspots, and thus improving its accuracy.

Using the simulation engine to determine height variations in semiconductor specimens may not be suitable for real-time applications, as running the simulation is time-consuming. This would require excessive time to obtain the height data from the model for each iteration, slowing down the process and making it impractical for real-time operations. To circumvent this problem, knowledgebase approach is adopted. Instead of solving the problem by applying the simulation engine in real-time, a knowledgebase (or library, referred to herein as “GL-to-height library”) is created with simulation outputs for a range of cases. Each entry in the library corresponds to graphical features and the respective height values obtained for these features by the simulation engine, by applying the simulation engine offline. For example, a database can be constructed, where each entry in the database comprises, several features characterizing a structural variation of the semiconductor specimen. The features can include, for example, structural and pattern geometry (which can be obtained from the stack information). The entry indicates the relevant graphical features exhibited in the SEM output images and the respective height values determined by the simulation engine.

While the range of cases can encompass a significant number of potential structural variations, it is practical to limit this range to manage processing demands effectively. For instance, if the range of height variations typically spans from 0 to 20 nanometers, the simulation will specifically target this range alone. By restricting the application of the simulation engine when building the library to areas that exhibit topography that aligns with the expected range of height variations, processing load and processing time required during the library build can be reduced, while ensuring the model remains focused on relevant scenarios.

During runtime, when SEM collects the grayscale data, the system does not apply this data directly to the simulation engine. Instead, it finds the closest entry in the library and retrieves the respective height from this pre-calculated data. The closest entry can be identified for example, by matching between the signal intensity in the image and the entry of the closest signal intensity in the library. If the exact value is not found, interpolation can be applied to determine the closest existing values. This approach enables the determination of height in real-time, based on the SEM GL output, without the delays associated with running the simulation engine. It is noted, however, that using the simulation engine directly, instead of a library, is also contemplated to be within the scope of the presently disclosed subject matter.

FIG. 4b is a flowchart showing operations carried out when determining height values based on a GL-to-height library. Following the determination of a simulation engine as explained with reference to FIG. 4a, a knowledgebase is created (419, e.g., by library generator 19). The knowledgebase can then be used for determining height values in real-time (421).

As explained above, one implementation of height measurements is during a CMP process for validating the DFM model output. The DFM model may exhibit inaccuracies in hotspots detection, while traditional methods, like OCD for validating hotspots, perform poorly at transition areas. The calibrated simulation engine or knowledgebase can be used for the validation of hotspots and for improving the performance of the DFM model.

FIG. 6 is a modified version of the flowchart shown in FIG. 3 demonstrating the incorporation of a knowledgebase validation procedure as part of the CMP analysis process, according to some examples of the presently disclosed subject matter. For the sake of clarity and completeness, and by way of non-limiting example only, some operations in FIG. 6 are described with reference to components of system 100 in FIGS. 1 and 2.

During an offline phase before execution of the CMP analysis process, the simulation engine of a certain semiconductor specimen that is being examined, is generated as described above with reference to FIG. 4a (block 601). Following generation of the simulation engine, a GL-to-height library is constructed using the simulation engine (block 603; e.g., by library generator 19). In some examples, the generation of the simulation engine and the construction of the GL-to-height library are performed together in one unified process. The GL-to-height library is stored in a computer data-repository (e.g., storage unit 122).

Both the simulation engine and the library are semiconductor specimen specific, as they are generated for a particular semiconductor specimen. The offline phase is executed as a preparatory stage using a 3D physical model and stack information of a certain semiconductor specimen before a CMP analysis is applied on the semiconductor specimen.

Once the relevant GL-to-height library is available, the CMP analysis process is executed. Operations carried out as part of the CMP analysis process follow the sequence described above with reference to FIG. 3 with some modifications, stipulated below. In some examples, operations mentioned with reference to blocks 301 to 317 are executed by hotspots rectifier 16.

Following generation of the hotspot map (block 305), a knowledgebase hotspot validation procedure is executed (blocks 605 to 613 in FIG. 6; e.g., by hotspots validator 18). Hotspots identified by the DFM model are analyzed and validated using the GL-to-height library. This includes navigating to the relevant area on the semiconductor specimen where the hotspot is located and scanning the relevant area using a SEM to obtain the corresponding GL images, or otherwise obtaining previously generated relevant scanning output (block 605). To this end, CMP analyzer 20 can communicate with a SEM (examination tool 120), provide information about the location of hotspots in the semiconductor specimen, and receive the scanning output images from the SEM following scanning.

The closest entry is found in the GL-to-height library, and the relevant height data is retrieved from the library (block 607). The height data obtained from the library is used for validating the hotspot (block 609). As explained above, the DFM model identifies hotspots based on a comparison of height values with a predefined threshold, which can be based, for example, on a nominal height value or a gradient between close points. During validation of a certain hotspot, the relevant height values of the hotspot are determined using the knowledgebase, and the hotspot determination is repeated, using the SEM output and knowledgebase. In some examples, if the difference in height values, between the DFM model hotspot determination and the knowledgebase hotspot determination is smaller than a certain threshold value, the hotspot is validated. Otherwise, negative feedback indicating the discrepancy is generated.

In some examples, feedback can be provided to the DFM model indicating whether the prediction that was made regarding the hotspot that was validated was correct or not (block 611). The feedback is used for updating the DFM model (block 613), where positive feedback reinforces the DFM model and negative feedback induces self-correction on the model. This enables to improve the DFM model's accuracy, enabling more precise predictions of hotspots in future CMP cycles. Each feedback cycle refines the model's parameters, improving its predictive capabilities and ensuring higher yields and better semiconductor specimen quality. This iterative improvement process increases manufacturing efficiency and reduces the need for post-fabrication corrections, thus lowering production costs and time.

If the hotspot is validated (affirmative result of 609), the CMP analysis continues with the dummy fill simulation (block 309), updating of the CAD design (311) and so forth.

It can be appreciated that while the DFM simulation is conducted across the entire semiconductor specimen, offering a faster processing time, the knowledgebase hotspots validation procedure is selectively applied only to hotspots. This targeted approach is adopted due to the slower, but more focused and detailed analysis required at these critical areas, optimizing both accuracy and resource utilization.

Consider a client engaged in manufacturing of a complex semiconductor specimens, who faces challenges in accurately identifying hotspots for dummy fill applications. The client must currently navigate the intrinsic uncertainties of the DFM model. By providing more precise height data at these hotspots, the effectiveness of the DFM model can be significantly enhanced. This improvement is facilitated through a largely non-destructive evaluation method. Aside from a limited number of sample analyses required during the model development phase, the method remains non-intrusive, preserving the integrity of the samples.

The term “semiconductor specimen”, as used herein, refers to a wafer, die, or part thereof made of semiconductor materials including for example silicon, gallium arsenide, or germanium. These specimens are used in the development, manufacturing, and testing of semiconductor devices, such as transistors, diodes, and integrated circuits, to study their properties and performance.

While certain examples of the present disclosure refer to a processing circuitry being configured to perform the above recited operations, the functionalities/operations of the aforementioned functional modules can be performed by the one or more processors in the processing circuitry in various ways. By way of example, the operations of each module can be performed by a specific processor, or by a combination of processors. The operations of the various functional modules, such as processing the examination/inspection image, and performing defect examination, etc., can thus be performed by respective processors (or processor combinations), while, optionally, these operations may be performed by the same processor. The present disclosure should not be limited to being construed as one single processor always performing all the operations. Furthermore, any reference made in the specification or claims to a single processing circuitry should be interpreted to optionally include multiple processing circuitries.

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1. For example, simulation engine 15 may be implemented as part of semiconductor processing configuration unit 5 rather than an individual unit.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

The system illustrated in FIG. 1 can be implemented in a distributed computing environment, in which one or more of the aforementioned components and functional modules shown in FIG. 1 can be distributed over several local and/or remote devices. By way of example, the examination tool 120 and the system 101 can be located at the same entity (in some cases hosted by the same device) or distributed over different entities, each located at a different location.

In some examples, certain components utilize a cloud implementation, e.g., implemented in a private or public cloud. Communication between the various components of the examination system, in cases where they are not located entirely in one location or in one physical entity, can be realized by any signaling system or communication components, modules, protocols, software languages and drive signals, and can be wired and/or wireless, as appropriate.

It should be further noted that in some examples at least some of examination tools 120 and/or storage unit 122 and/or UI 121 can be external to system 101 and operate in data communication with systems 101 over a suitable communication link. System 101 can be implemented as stand-alone computer(s) to be used in conjunction with the examination tools, and/or with the additional examination modules as described above. Alternatively, the respective functions of system 101 can, at least partly, be integrated with one or more examination tools 120, thereby facilitating and enhancing the functionalities of the examination tools 120.

Unless specifically stated otherwise, as apparent from the above discussions, it is appreciated that, throughout the specification, discussions utilizing terms such as “obtaining”, “extracting”, “validating”, “confirming”, “applying”, or the like, include an action and/or processes of a computer that manipulate and/or transform data into other data, said data represented as physical quantities, e.g. such as electronic quantities, and/or said data representing the physical objects.

The terms “computer”, “computer system”, “computer device”, “computerized device”, “computerized system” or the like used herein, should be expansively construed to include any kind of hardware-based electronic device with one or more data processing circuitries. Each processing circuitry can comprise, for example, one or more processors operatively connected to computer memory, capable of executing stored instructions to perform the operations described herein. Any reference made in the description or claims to a processing circuitry should be construed to include also multiple processing circuitries.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a graphics processing unit (GPU), a network processor, or the like.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

In embodiments of the presently disclosed subject matter, fewer, more and/or different stages than those shown in FIGS. 3, 4a, 4b and 6 may be executed. In embodiments of the presently disclosed subject matter, one or more stages, illustrated in the figures, may be executed in a different order, and/or one or more groups of stages may be executed simultaneously.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable (e.g., non-transitory) memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer-implemented method of augmenting Chemical Mechanical Planarization (CMP) of a semiconductor specimen, the method comprising:
obtaining data indicative of one or more CMP hotpots in the semiconductor specimen, wherein each CMP hotspot is an area on the semiconductor specimen being suspected of requiring planarity adjustments by dummy fill;
performing a hotspot validation procedure:
for each CMP hotspot:
obtaining scanning output (GL) images of the hotspot generated by a Scanning Electron Microscope (SEM);
extracting from a prestored knowledgebase (e.g., library) height values of the hotspot according to graphical features extracted from the scanning output (GL) images; wherein the knowledgebase comprises data associating graphical features scanning output images, generated by SEM, with respective height values in the semiconductor specimen;
validating the CMP hotspot by confirming if the height values meet one or more conditions, or rejecting them if they do not;
confirming dummy fill at the CMP hotspot if the CMP hotspot is validated.

2. The method of claim 1, wherein the hotspots validation procedure comprises, for each CMP hotspot, scanning the CMP hotspot area on the semiconductor specimen using a SEM to generate the scanning output (GL) images.

3. The method of claim 1 further comprising:
obtaining the data indicative of one or more CMP hotspots by applying a Design for Manufacturing (DFM) model on a design model (e.g. CAD design) of the semiconductor specimen;
in case the hotspot is validated, updating the design model to include simulated dummy fill at the CMP hotspot area to thereby obtain an updated design model; and re-applying the DFM model on the updated design model to receive data indicative of one or more CMP hotspots in the semiconductor specimen.

4. The method of claim 1 further comprising:
obtaining the data indicative of one or more CMP hotspots by applying a Design for Manufacturing (DFM) model on a design model (e.g. CAD design) of the semiconductor specimen; and providing feedback to DFM model and updating the DFM model according to the validation output, thus augmenting the DFM model.

5. The method of claim 1 comprising an offline phase executed before the execution of the hotspot validation procedure, the offline phase comprising:
generating a 3D physical model of the semiconductor specimen based on structural and material characteristics;
determining stack information of the semiconductor specimen;
configuring, based on the stack information and the 3D physical model, a simulation engine adapted to correlate graphical features extracted from SEM imaging output images, with corresponding height values in the semiconductor specimen.

6. The method of claim 5 comprising calibrating the simulation engine, comprising:
obtaining scanning output images of a selected area in the semiconductor specimen that comprises CMP hotspots;
applying graphical features extracted from the scanning output images to the simulation engine to thereby obtain respective height values;
measuring height values in the selected area using a high-resolution imaging technique to obtain measured height values;
determining a calibration coefficient based on a difference between the respective height values and measured height values; the calibration coefficient is dedicated for correcting errors in height values determined by the simulation engine.

7. The method of claim 5 wherein the offline phase further comprises:
applying the simulation engine on graphical features extracted from different areas in the semiconductor specimen to determine respective height values; storing the graphical features and their respective height values as entries in a database, each entry corresponding to graphical features and respective height values generated, provided by the simulation engine.

8. The method of claim 7 comprising, restricting application of the simulation engine to areas that exhibit topography that aligns with an expected range of height variations to thereby reduce processing load and time needed for generating the database.

9. A computer system configured and operable to execute an augmented Chemical Mechanical Planarization (CMP) process of a semiconductor specimen, the computer system comprising a processing circuitry configured to:
obtain data indicative of one or more CMP hotpots in the semiconductor specimen, wherein each CMP hotspot is an area on the semiconductor specimen being suspected of requiring planarity adjustments by dummy fill;
perform a hotspot validation procedure comprising:
for each CMP hotspot:
obtaining scanning output (GL) images the hotspot generated by a Scanning Electron Microscope (SEM);
extracting from a prestored knowledgebase (e.g., library) height values of the hotspot according to graphical features extracted from the scanning output (GL) images; wherein the knowledgebase comprises data associating graphical features scanning output images generated by SEM, with respective height values in the semiconductor specimen;
validating the CMP hotspot by confirming if the height values meet one or more conditions, or rejecting if they do not;
confirming dummy fill at the CMP hotspot if the CMP hotspot is validated.

10. The computer system of claim 9, wherein the hotspots validation procedure comprises, for each CMP hotspot, scanning the CMP hotspot area on the semiconductor specimen, using SEM, to generate the scanning output (GL) images.

11. The computer system of claim 9, wherein the processing circuitry is configured to:
apply a Design for Manufacturing (DFM) model on a design model of the semiconductor specimen to thereby obtain the data indicative of one or more CMP hotpots in the semiconductor specimen;
in case the hotspot is validated, update the design model to include simulated dummy fill at the CMP hotspot area to thereby obtain an updated design model; and re-apply the DFM model on the updated design model to receive data indicative of one or more CMP hotspots in the semiconductor specimen.

12. The computer system of claim 9, wherein the processing circuitry is configured to:
apply a Design for Manufacturing (DFM) model on a design model of the semiconductor specimen to thereby obtain the data indicative of one or more CMP hotpots in the semiconductor specimen; and
provide feedback to DFM model and updating the DFM model according to the validation output, thus augmenting the DFM model.

13. The computer system of claim 9, wherein the processing circuitry is configured to execute an offline phase before the execution of the hotspot validation procedure, the offline phase comprising:
generating a 3D physical model of the semiconductor specimen based on structural and material characteristics;
determining stack information of the semiconductor specimen;
configuring, based on the stack information and the 3D physical model a simulation engine adapted to correlate graphical features extracted from SEM imaging output images, with corresponding height values in the semiconductor specimen.

14. The computer system of claim 13, wherein the processing circuitry is configured to execute calibration of the simulation engine, comprising:
obtaining scanning output images of a selected area in the semiconductor specimen that comprises CMP hotspots;
applying graphical features extracted from the scanning output images to the simulation engine to thereby obtain respective height values;
measuring height values in the selected area using a high-resolution imaging technique to obtain measured height values;
determining a calibration coefficient based on a difference between the respective height values and measured height values; the calibration coefficient is dedicated for correcting errors in height values determined by the simulation engine.

15. The computer system of claim 13, wherein the processing circuitry is configured to perform during the offline phase:
apply the simulation engine on graphical features extracted from different areas in the semiconductor specimen to determine respective height values; store the graphical features and their respective height values as entries in a database, each entry corresponding to graphical features and respective height values generated, provided by the simulation engine.

16. A non-transitory computer readable storage medium tangibly embodying a program of instructions that, when executed by a computer, cause the computer to perform a method of a method of augmenting Chemical Mechanical Planarization (CMP) of a semiconductor specimen, the method comprising:
obtaining data indicative of one or more CMP hotpots in the semiconductor specimen, wherein each CMP hotspot is an area on the semiconductor specimen being suspected of requiring planarity adjustments by dummy fill;
performing a hotspot validation procedure:
for each CMP hotspot:
obtaining scanning output (GL) images the hotspot generated by a Scanning Electron Microscope (SEM);
extracting, from a prestored knowledgebase, height values of the hotspot according to graphical features extracted from the scanning output (GL) images; wherein the knowledgebase comprises data associating graphical features scanning output images generated by SEM, with respective height values in the semiconductor specimen;
validating the CMP hotspot by confirming if the height values meet one or more conditions, or rejecting them if they do not;
confirming dummy fill at the CMP hotspot if the CMP hotspot is validated.
